(19) United States
(12) Patent Application Publication
(10) Pub. No.: US 2013/0014017 A1
(43) Pub. Date: Jan. 10, 2013

(54) INFORMATION PROCESSING APPARATUS, CONTROL METHOD THEREFOR AND COMPUTER-READABLE RECORDING MEDIUM

(75) Inventor: Tomoya Sato, Kawasaki-shi (JP)

(73) Assignee: CANON KABUSHIKI KAISHA, Tokyo (JP)

(21) Appl. No.: 13/494,062

(22) Filed: Jun. 12, 2012

(30) Foreign Application Priority Data
Jul. 4, 2011 (JP) 2011-148622

(51) Int. Cl. G06F 3/01

(52) U.S. Cl. 715/733

(57) ABSTRACT

An information processing apparatus (MFP) of the invention accepts designation of screen data which has been embedded in the information processing apparatus in advance, or screen data of an external server apparatus (Web server) which provides the screen data of an operation screen. If the screen data provided by the Web server is designated, the MFP obtains the screen data from the Web server, and determines whether it is possible to display the operation screen based on the obtained screen data as the menu screen on an operation unit. If the MFP determines that it is impossible to display, as the menu screen, the operation screen based on the screen data provided by the Web server, it restricts the use of the screen data, and accepts designation of new screen data.

### BACKGROUND OF THE INVENTION

1. Field of the Invention

The present invention relates to an information processing apparatus such as an MFP, a control method therefor, and a computer-readable recording medium.

2. Description of the Related Art

There is generally well known a technique in which an information processing apparatus such as a PC displays an operation screen on its display unit based on data that is provided by a server apparatus such as a Web server on a network. For example, the Web browser of the information processing apparatus transmits, to the Web server on the network, a request for contents necessary for displaying the operation screen on the display unit. Upon receiving the request, a Web application on the Web server transmits the contents for displaying the operation screen by the Web browser to the information processing apparatus. The contents contain, for example, HTML data, an image file, and a script file. The Web browser of the information processing apparatus analyzes the received contents, and displays the operation screen based on the description of the analyzed contents on the display unit of the information processing apparatus. Furthermore, upon accepting a user instruction by an input through the displayed operation screen, the Web browser notifies the Web server of the input instruction. Upon receiving the notification, the Web application on the Web server executes processing according to the sent instruction.

In recent years, as will be described later, some multi function peripherals (MFPs) including a scanner and printer comprise a Web browser as described above. Such an MFP causes its Web browser to display, on a display unit, an operation screen based on contents provided by a Web server according to the above-described procedure. The MFP also accepts various instructions from the user through the displayed operation screen.

For example, Japanese Patent Laid-Open No. 2006-127503 has proposed a technique in which a Web server provides an MFP with the data (menu data) of an operation screen for allowing the user to use each function of the MFP. The user of the MFP inputs an instruction to the MFP through the operation screen which is displayed on a UI panel by a Web browser. The Web browser of the MFP notifies the Web server of the input instruction. Upon receiving the notification, the Web server transmits, as a processing execution request, data (device control data) for controlling the MFP to the MFP according to a communication protocol such as SOAP (Simple Object Access Protocol) in order to cause the MFP to execute processing according to the contents of the sent instruction. Upon receiving the execution request, the MFP executes the requested processing. According to Japanese Patent Laid-Open No. 2006-127503, executing such processing between the Web server and the MFP eliminates the need to hold, in the MFP, all menu data for operating the MFP. It is also possible to readily change the menu data not on the MFP but on the Web server.

Some recent MFPs display, as a menu screen (function selection screen), a list of icons and the like used by the user to select a function to be used, thereby enabling the user to select a desired function from the displayed icons. In this case, the MFP generally uses an application on itself to implement a “menu function” to display the menu screen which prompts the user to select a function of the MFP. (The application for implementing the “menu function” on the MFP will also be referred to as a “menu application” hereinafter.) The operation unit of the MFP generally includes, as a “menu key”, a key (button) dedicated to calling of the menu application so that the user can call the menu application by performing an easy operation to use the menu screen. This menu key is associated with the menu function for displaying the menu screen on the display unit of the MFP. When the user presses the menu key or the MFP starts from a power-off state, the MPF displays the menu screen provided by the menu application on the display unit.

Recent MFPs have many functions. These functions tend to be used in various methods depending on an organization or the like in which the MFP is used. For such an MFP, it is desirable to be able to change (customize) an operation screen to meet the needs of the user. In particular, since the above-described menu screen is also used in starting the MFP, and its use frequency becomes highest, it may be highly desirable for the user to be able to customize the menu screen.

For an MFP which can display an operation screen based on contents provided by an external Web server as described above, however, there has not been provided a function in which the user freely customizes a menu screen by designating contents to be provided by the Web server. This is because the user may erroneously set, as an application for providing a menu screen, the Web application of the Web server which cannot actually provide the contents of the menu screen. If the user erroneously sets the Web application which cannot provide a menu screen, another screen may be inadvertently displayed instead of the menu screen when the menu key of the MFP is pressed or the MFP starts. As a result, the user cannot select a function to be used through the screen displayed on the display unit of the MFP, and cannot even cause transition of the screen display to another screen.

### SUMMARY OF THE INVENTION

The present invention has been made in consideration of the above problems, and provides a technique for enabling customization of a menu screen for accepting function selection in an information processing apparatus which can display an operation screen based on screen data provided by a server apparatus.

According to one aspect of the present invention, there is provided an information processing apparatus which is capable of communicating, via a network, with a server apparatus for providing screen data of an operation screen, comprising: an acceptance unit configured to accept designation of screen data provided by the server apparatus as screen data of a menu screen for accepting selection of a function of the information processing apparatus to be used; an obtaining unit configured to obtain the designated screen data from the server apparatus; a determination unit configured to determine whether it is possible to display, as the menu screen, the operation screen based on the screen data obtained by the obtaining unit on a display unit included in the information processing apparatus; and a restriction unit configured to restrict, if the determination unit determines that it is impossible to display the operation screen based on the obtained screen data as the menu screen on the display unit, the use of the designated screen data as the screen data of the menu screen.

According to another aspect of the present invention, there is provided an information processing apparatus which is capable of communicating, via a network, with a server apparatus for providing screen data of an operation screen, comprising: an acceptance unit configured to accept registration of specifying information for uniquely specifying screen data of an operation screen provided by the server apparatus; an obtaining unit configured to obtain the screen data specified by the registered specifying information from the server apparatus; a determination unit configured to determine whether it is possible to display, as a menu screen for accepting selection of a function of the information processing apparatus to be used, the operation screen based on the screen data obtained by the obtaining unit on a display unit included in the information processing apparatus; and a selection unit configured to select screen data to be used to display the menu screen from screen data which has been embedded in the information processing apparatus in advance, and screen data which is specified by the registered specifying information and for which the determination unit has determined that it is possible to display the operation screen based on the obtained screen data as the menu screen on the display unit.

According to still another aspect of the present invention, there is provided a control method for an information processing apparatus which is capable of communicating, via a network, with a server apparatus for providing screen data of an operation screen, comprising: accepting designation of screen data provided by the server apparatus as screen data of a menu screen for accepting selection of a function of the information processing apparatus to be used; obtaining the designated screen data from the server apparatus; determining whether it is possible to display, as the menu screen, the operation screen based on the screen data obtained in the obtaining on a display unit included in the information processing apparatus; and restricting, if it is determined in the determining that it is impossible to display, as the menu screen, the operation screen based on the obtained screen data on the display unit, the use of the designated screen data as the screen data of the menu screen.

According to yet another aspect of the present invention, there is provided a control method for an information processing apparatus which is capable of communicating, via a network, with a server apparatus for providing screen data of an operation screen, comprising: accepting registration of specifying information for uniquely specifying screen data of an operation screen provided by the server apparatus; obtaining the screen data specified by the registered specifying information from the server apparatus; determining whether it is possible to display, as a menu screen for accepting selection of a function of the information processing apparatus to be used, the operation screen based on the screen data obtained in the obtaining on a display unit included in the information processing apparatus; and selecting screen data to be used to display the menu screen from screen data which has been embedded in the information processing apparatus in advance, and screen data which is specified by the registered specifying information and for which it is determined in the determining that it is possible to display the operation screen based on the obtained screen data as the menu screen on the display unit.

According to the present invention, there can be provided a technique for enabling customization of a menu screen for accepting function selection in an information processing apparatus which can display an operation screen based on screen data provided by a server apparatus. It is also possible to prevent the user from setting, as an application for providing the menu screen, an application which cannot provide the menu screen.

Further features of the present invention will become apparent from the following description of exemplary embodiments (with reference to the attached drawings).

### BRIEF DESCRIPTION OF THE DRAWINGS

FIG. 1 is a view showing the overall configuration of an information processing system 100 according to the first embodiment of the present invention;

FIG. 2 is a block diagram showing the configuration of an MFP 101 according to the first embodiment of the present invention;

FIG. 3 is a view showing the outer appearance of an operation unit 219 of the MFP 101 according to the first embodiment of the present invention;

FIG. 4 is a block diagram showing the configuration of a Web server 102 according to the first embodiment of the present invention;

FIG. 5 is a block diagram showing the software configuration of the information processing system 100 according to the first embodiment of the present invention;

FIG. 6 is a flowchart illustrating a procedure of setting a menu function in the MFP 101 according to the first embodiment of the present invention;

FIG. 7 is a view showing an example of a menu function setting screen in the first embodiment of the present invention;

FIG. 8 is a view showing an example of screen data (an HTML file) of a menu screen in the first embodiment of the present invention;

FIG. 9 is a flowchart illustrating a procedure of displaying the menu screen in the MFP 101 according to the first embodiment of the present invention;

FIG. 10 is a view showing an example of a menu screen provided by a Web application 510 according to the first embodiment of the present invention;

FIG. 11 is a view showing an example of a menu screen provided by an embedded menu function unit 536 according to the first embodiment of the present invention;

FIG. 12 is a table showing an example of a management table managed by a favorites management unit 544 according to the second embodiment of the present invention;

FIG. 13 is a flowchart illustrating a processing procedure of setting a menu function in an MFP 101 according to the second embodiment of the present invention; and

FIG. 14 is a view showing an example of a menu function setting screen in the second embodiment of the present invention.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

### First Embodiment

<Hardware Configuration of Information Processing System 100>

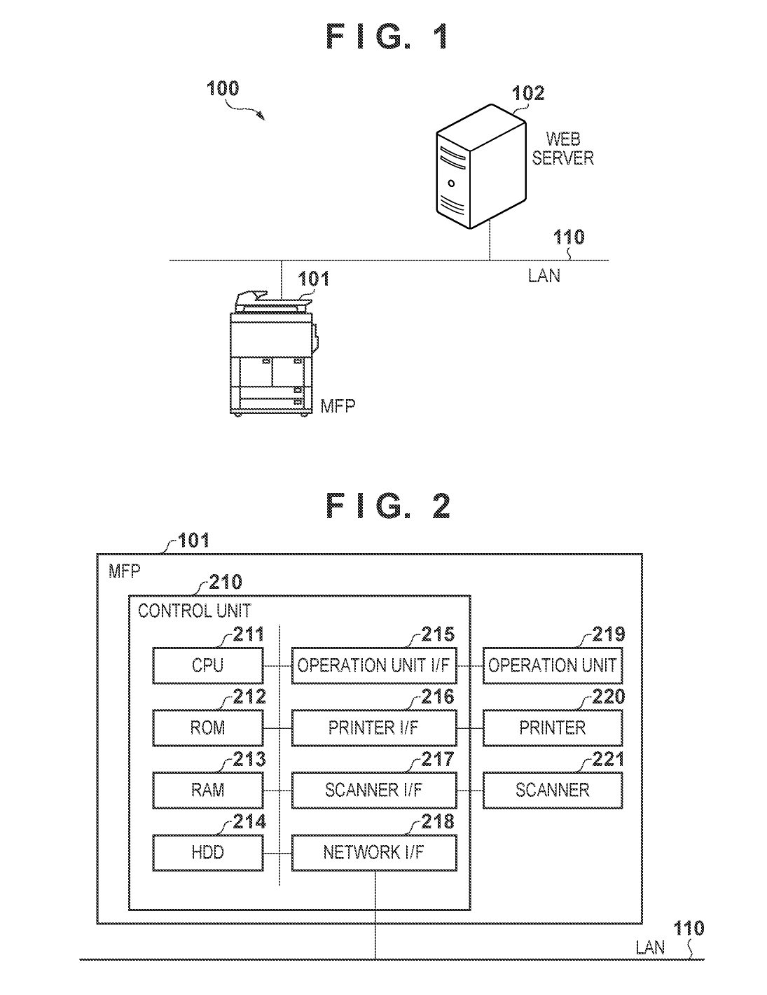

The first embodiment of the present invention will be described first. FIG. 1 is a schematic view showing the overall information processing system 100 according to the first embodiment. An MFP 101 and a Web server 102 are communicably connected with a LAN 110. Although FIG. 1 shows a case in which one MFP 101 and one Web server 102 are connected with the LAN 110 as an example of a network, any numbers of MFPs 101 and Web servers 102 may be connected with the LAN 110. Furthermore, the MFP 101 and Web server 102 may be communicably connected via the Internet. Note that in this embodiment, the Web server 102 is an example of a server apparatus for providing the screen data of an operation screen, and the MFP 101 is an example of an information processing apparatus which can communicate with the server apparatus via a network.

(Configuration of MFP 101)

FIG. 2 is a block diagram showing the configuration of the MFP 101. The MFP 101 includes devices such as a control unit 210 for controlling the whole operation of the MFP 101, an operation unit 219, a printer 220, and a scanner 221. The MFP 101 includes a CPU 211 which performs various control operations such as a printing control operation, a reading control operation, and a transmission control operation by loading, into a RAM 213, control programs stored in a ROM 212. The RAM 213 is used as a main memory for the CPU 211 and as a temporary storage area such as a work area. An HDD 214 stores image data, various programs, or various information tables.

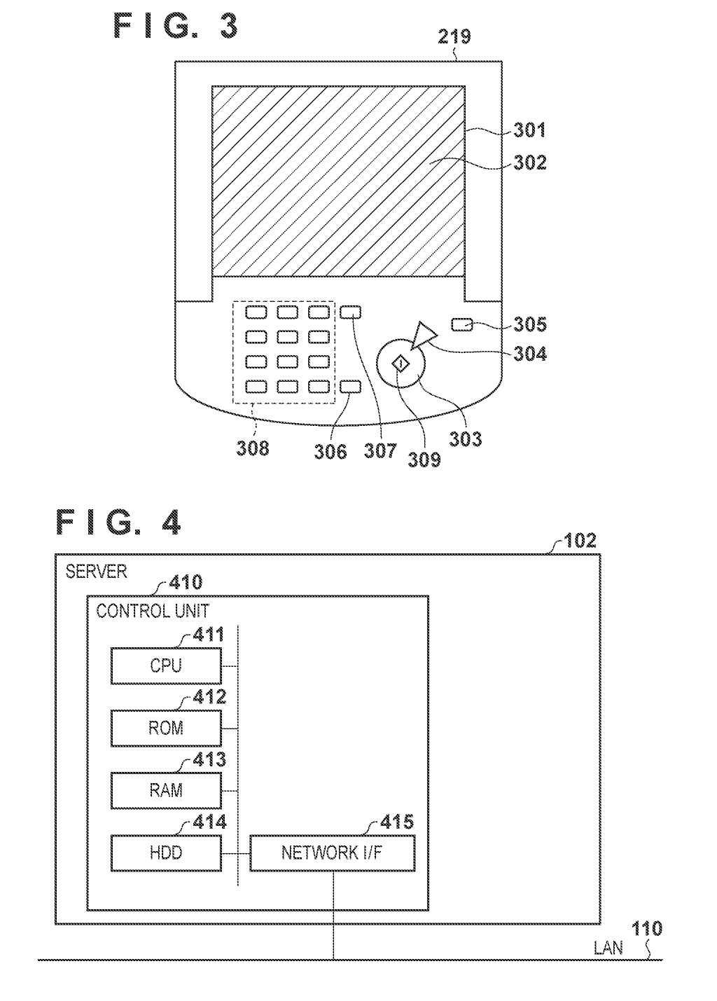

An operation unit interface (I/F) 215 is used to connect the operation unit 219 with the control unit 210. As will be described later with reference to FIG. 3, the operation unit 219 includes a keyboard and a liquid crystal display (LCD) unit having a touch panel function. The LCD unit functions as a display unit for displaying various kinds of information. Furthermore, the operation unit 219 functions as a user interface (UI) used by the user to input various kinds of information and instructions to the MFP 101.

As will be described later, the MFP 101 includes a Web browser as one function which is implemented by executing a control program. The Web browser of the MFP 101 analyzes contents (screen data) such as HTML data received from the Web server 102, and then displays an operation screen based on the description of the analyzed contents on the LCD unit of the operation unit 219.

A printer I/F 216 is used to connect the printer 220 with the control unit 210. Image data to be printed by the printer 220 is transferred from the control unit 210 via the printer I/F 216. The printer 220 prints an image on a printing medium based on the transferred image data. A scanner I/F 217 is used to connect the scanner 221 with the control unit 210. The scanner 221 reads an image on a document to generate image data, and inputs the generated image data to the control unit 210 via the scanner I/F 217.

A network I/F 218 is used to connect the control unit 210 (MFP 101) to the LAN 110. The network I/F 218 transmits image data and various kinds of information to an external apparatus (for example, the Web server 102) on the LAN 110, and receives various kinds of information from an external apparatus on the LAN 110.

(Configuration of Operation Unit 219)

FIG. 3 is a view showing the outer appearance of the operation unit 219 provided for the MFP 101. The operation unit 219 includes an LCD unit 301 formed by an LCD and a touch panel sheet 302 laminated on the LCD, and various hard keys 303 to 308. A native function module (to be described later) and the Web browser display an operation screen (including a menu screen) and soft keys on the LCD unit 301. When the user presses one of the soft keys through the touch panel sheet 302 while the keys are displayed on the LCD unit 301, the LCD unit 301 notifies the CPU 211 of position information indicating a position on the touch panel sheet 302 where the user has pressed.

The operation unit 219 includes, as the various hard keys 303 to 308, the start key 303, stop key 304, reset key 305, guide key 306, menu key 307, and numeric keys 308. The start key 303 is used to instruct the start of processing in the MFP 101. A two-color LED display unit 309 having LEDs of two, green and red is arranged at the center of the start key 303. The two-color LED display unit 309 indicates by its color whether the start key 303 is available. The stop key 304 is used to stop an operation being executed. The reset key 305 is used to initialize settings. The guide key 306 is used to display the usage of the MFP 101 on the LCD unit 301.

The menu key 307 is used to display, on the LCD unit 301, a menu screen (function selection screen) for selecting a function of the MFP 101 to be used. The menu screen is also displayed when the MFP 101 starts from a power-off state, and corresponds to a top menu screen. Note that the operation of the MFP 101 when the menu key 307 is pressed will be described later. The numeric keys 308 are used to input numeric values.

(Configuration of Web Server 102)

FIG. 4 is a block diagram showing the configuration of the Web server 102. A control unit 410 including a CPU 411 controls the whole operation of the Web server 102. The CPU 411 executes various control operations by loading, into a RAM 413, control programs stored in a ROM 412. The RAM 413 is used as a main memory for the CPU 411 and as a temporary storage area such as a work area. An HDD 414 stores image data and various programs. A network I/F 415 is used to connect the control unit 410 (Web server 102) to the LAN 110. The network I/F 415 transmits/receives various kinds of information to/from another apparatus on the LAN 110.

<Software Configuration of Information Processing System 100>

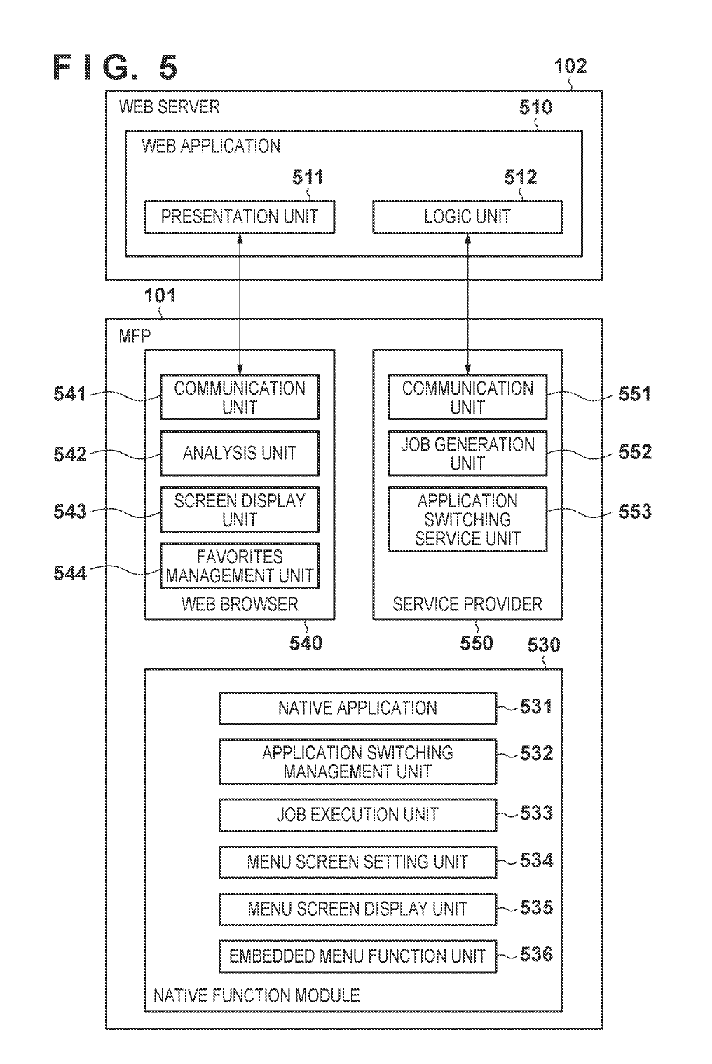

FIG. 5 is a block diagram showing the software configuration of the overall information processing system 100. Respective function units shown in FIG. 5 are implemented on the MFP 101 and Web server 102 when the CPU 211 of the MFP 101 and the CPU 411 of the Web server 102 respectively execute control programs. The MFP 101 includes a native function module 530, Web browser 540, and service provider 550 as the function units which are implemented when the CPU 211 executes the control programs. On the other hand, the Web server 102 includes a Web application 510 as the function unit which is implemented when the CPU 411 executes the control program. Note that in this embodiment, the Web browser 540 and a menu screen display unit 535 function as a display control unit.

(Software Configuration of MFP 101)

The Web browser 540 includes a communication unit 541, analysis unit 542, screen display unit 543, and favorites management unit 544. The communication unit 541 communicates with a presentation unit 511 included in the Web application 510 of the Web server 102 according to the HTTP protocol. More specifically, the communication unit 541 transmits, to the Web application 510, a request for the contents of an operation screen to be displayed on the operation unit 219 (LCD unit 301) by the Web browser 540. The communication unit 541 transmits the request as an HTTP request to the Web application 510, and receives, as its response, the contents of the operation screen from the Web application 510. When the user inputs an instruction (information) through the operation screen which the Web browser 540 has displayed based on the contents received from the Web application 510, the communication unit 541 notifies the Web application 510 of the input instruction.

The analysis unit 542 analyzes the contents of the operation screen received from the Web application 510. The contents contain, for example, an HTML file, an image file, and a script file. These files contain a description indicating the contents of the operation screen to be displayed on the operation unit 219. The screen display unit 543 displays the operation screen on the LCD unit 301 of the operation unit 219 based on a result of analyzing the contents by the analysis unit 542.

The favorites management unit 544 registers, as “favorites”, URLs for specifying the Web server 102, the Web application 510, the contents of the operation screen, and the like according to user instructions. It is possible to register an arbitrary name in association with a URL as “favorites”. In general, “favorites” is also called “bookmarks” or “Internet shortcuts”. The favorites management unit 544 holds favorite information including a URL and arbitrary name as a management table in the RAM 213 or HDD 214. Furthermore, the favorites management unit 544 provides information included in the management table in response to a request from another function unit.

The service provider 550 includes a communication unit 551, job generation unit 552, and application switching service unit 553. The communication unit 551 communicates with a logic unit 512 included in the Web application 510 of the Web server 102. More specifically, the communication unit 551 accepts a processing execution request or application switching request from the Web application 510 (logic unit 512) via the LAN 110.

If the communication unit 551 accepts a processing execution request from the Web application 510, it passes the execution request to the job generation unit 552. The job generation unit 552 generates a job for executing processing according to the execution request from the Web application 510. The job generation unit 552 passes the generated job to a job execution unit 533 included in the native function module 530. On the other hand, if the communication unit 551 accepts an application switching request, it passes the switching request to the application switching service unit 553. The application switching service unit 553 requests the application switching management unit 532 to switch an application being executed according to the switching request from the Web application 510.

The native function module 530 includes a native application 531, application switching management unit 532, job execution unit 533, menu screen setting unit 534, menu screen display unit 535, and embedded menu function unit 536. The native application 531 indicates not an application provided by the Web server 102 but various applications provided based on programs held in the MFP 101. The native application 531 includes, for example, applications for respectively executing printing processing by the printer 220 of the MFP 101, reading processing by the scanner 221, and transmission processing via the network I/F 218. The job execution unit 533 executes the native application 531 or the job generated by the job generation unit 552 of the service provider 550.

The application switching management unit 532 executes application switching processing in response to a request from the native application 531, embedded menu function unit 536, or application switching service unit 553. The application switching processing corresponds to processing of switching an application for providing the data of a screen to be displayed on the operation unit 219 (LCD unit 301). With the switching processing by the application switching management unit 532, a window which is visible to the user on the operation unit 219 and is being displayed in front of other windows is switched to a window associated with a different application. The application switching management unit 532 notifies an application of information indicating that the application has been designated as a switching destination in the request from the native application 531, embedded menu function unit 536, or application switching service unit 553. Furthermore, the application switching management unit 532 displays a window generated by the designated application in front of other screens on the operation unit 219.

The menu screen setting unit 534 accepts settings associated with the display of the menu screen for the operation unit 219, and holds the accepted settings in the RAM 213 or HDD 214. In this embodiment, according to the settings, the user can customize the menu screen to be displayed on the operation unit 219. More specifically, the menu screen setting unit 534 accepts settings indicating an application (embedded menu function or Web application) which is to be used as an application for displaying the menu screen on the operation unit 219. When the user presses the menu key 307, when auto clear is instructed, or when the MFP 101 starts from a power-off state, the menu screen display unit 535 displays the menu screen on the operation unit 219 according to the settings held by the menu screen setting unit 534. Note that detailed processing by the menu screen setting unit 534 and menu screen display unit 535 will be described later.

The embedded menu function unit 536 is a software module which is called by the menu screen display unit 535, and displays, on the operation unit 219, a menu screen which has been embedded in the MFP 101 in advance. The embedded menu function unit 536 requests the application switching management unit 532 to execute application switching processing to any other application in response to a user instruction input through the operation unit 219. Note that the embedded menu screen displayed by the embedded menu function unit 536 will be described later.

(Software Configuration of Web Server 102)

The Web server 102 includes the Web application 510 which includes the presentation unit 511 and logic unit 512. The Web application 510 can communicate with each of the Web browser 540 and service provider 550 of the MFP 101 via the LAN 110 using the presentation unit 511 and logic unit 512. The presentation unit 511 communicates with the communication unit 541 of the Web browser 540. In response to a request from the MFP 101, the presentation unit 511 transmits, to the MFP 101, the contents of an operation screen to be displayed on the operation unit 219 by the Web browser 540. The Web application 510 (presentation unit 511) receives, from the Web browser 540, a user instruction input through the operation screen displayed on the operation unit 219 by the Web browser 540.

Upon receiving the user instruction from the Web browser 540, the Web application 510 generates a request to cause the MFP 101 to execute processing according to the contents of the instruction, and transmits the generated request to the MFP 101. For example, the Web application 510 requests the MFP 101 to execute printing processing by the printer 220 of the MFP 101, reading processing by the scanner 221, and transmission processing via the network I/F 218.

To request the MFP 101 to execute processing as described above, the logic unit 512 of the Web application 510 transmits the execution request to the communication unit 551 included in the service provider 550 of the MFP 101. The logic unit 512 requests, via the communication unit 551, the job generation unit 552 to generate a job for executing the processing according to the execution request. In addition to the request to execute the processing based on job generation, the Web application 510 may request the MFP 101 to switch an application depending on the contents of the instruction from the Web browser 540.

Although FIG. 5 shows only one Web application 510, the Web application 510 may include a plurality of Web applications which provide different screen data. In this embodiment, the Web browser 540 uses a URL as specifying information for uniquely specifying each Web application or screen data provided by each Web application, as will be described later.

<Processing of Setting Menu Function in MFP 101>

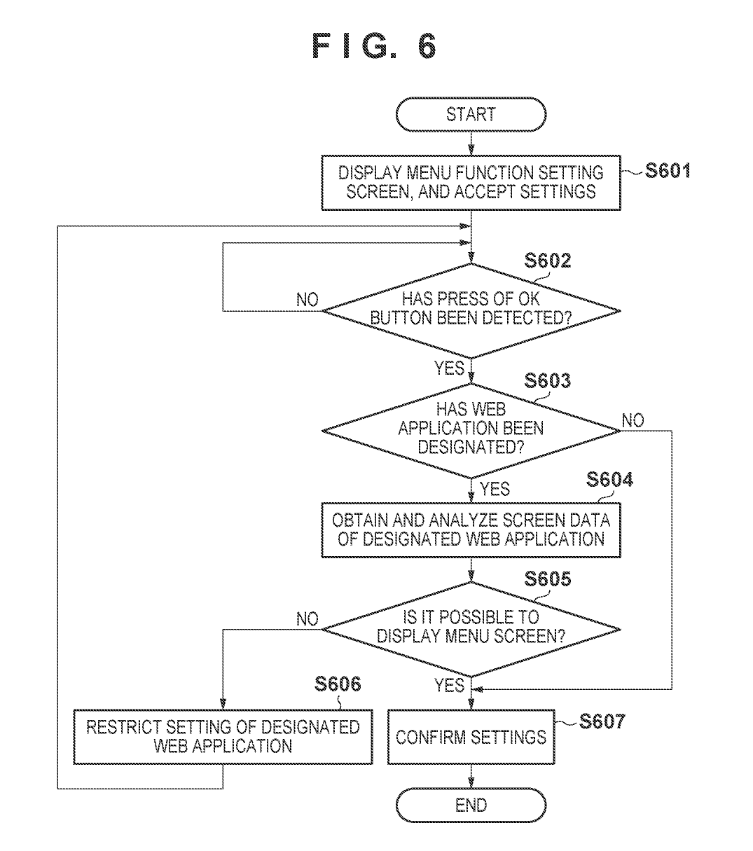

FIG. 6 is a flowchart illustrating a processing procedure of setting a menu function used to display, on the operation unit 219, the menu screen for prompting the user to select a function of the MFP 101, which is executed by the MFP 101 according to this embodiment. Each operation shown in the flowchart of FIG. 6 is implemented on the MFP 101 when the CPU 211 of the MFP 101 executes a control program (each software module shown in FIG. 5). More specifically, each operation of FIG. 6 is implemented by a function of the menu screen setting unit 534. When the user of the MFP 101 performs a specific operation for the operation unit 219 to call a function of the menu screen setting unit 534, the processing of FIG. 6 starts.

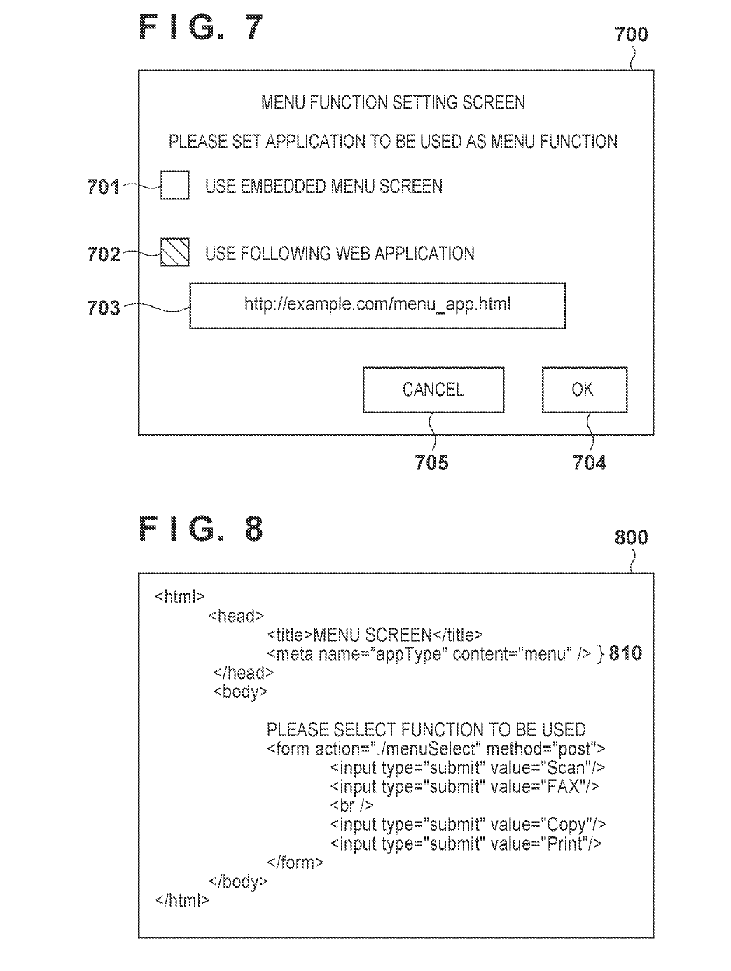

In step S601, the CPU 211 displays, on the operation unit 219, a “menu function setting screen” for making settings associated with the display of the menu screen, and accepts setting information input. An example (a screen 700) of the screen displayed on the operation unit 219 in step S601 will now be described in detail with reference to FIG. 7.

In the screen 700, a button 701 is used to set that the embedded menu screen should be used as the menu screen. On the other hand, a button 702 is used to set that a screen provided by one of Web applications operating on one (for example, the Web server 102) of Web servers on the network (LAN 110) should be used as the menu screen. The CPU 211 controls the display of the operation unit 219 to be in a state in which only one of the buttons 701 and 702 has been selected. Note that the CPU 211 displays a screen in which, for example, the button 701 has been selected in advance, that is, the use of the embedded menu screen has been selected by default.

When a screen provided by a Web application is used as the menu screen, a URL corresponding to the Web application is input in a text input field 703. Note that for the text input field 703, an input operation is enabled when the button 702 is selected, and an input operation is disabled when the button 701 is selected. The user designates the Web application for providing the screen data of the menu screen for the MFP 101 by inputting the URL in the text input field 703.

When the user selects the area of the text input field 703, the CPU 211 displays a soft keyboard screen (not shown) to enable the user to input a URL in the input field. When the user inputs the character string of a URL using the soft keyboard, the CPU 211 displays the input character string in the text input field 703. An OK button 704 is used to enable the setting and to cause the menu screen setting unit 534 to hold it. A cancel button 705 is used to return the display of the operation unit 219 to the original screen without enabling the setting made using the screen 700.

As described above, in step S601, the CPU 211 accepts, through the button 701, as the screen data of the menu screen, designation of the screen data which has been embedded in the MFP 101 in advance. Alternatively, the CPU 211 accepts, through the button 702 and text input field 703, as the screen data of the menu screen, designation of the screen data provided by the Web server (Web application) instead of the screen data which has been embedded in the MFP 101 in advance. In step S601, therefore, the CPU 211 functions as an acceptance unit.

In step S602, the CPU 211 determines whether press of the OK button 704 has been detected. As long as the CPU 211 determines that press of the OK button 704 has not been detected, it stands by until the OK button 704 is pressed by repeating the determination processing in step S601. On the other hand, if the CPU 211 determines that press of the OK button 704 has been detected, it advances the process to step S603.

In step S603, the CPU 211 determines whether it has been designated, through the screen 700, to use a Web application. If the CPU 211 determines that it has not been designated to use a Web application (that is, the button 701 has been selected), it advances the process to step S607. On the other hand, if the CPU 211 determines that it has been designated to use a Web application (that is, the button 702 has been selected), it advances the process to step S604.

In step S604, the CPU 211 obtains, via the LAN 110, contents specified by a URL designated in the text input field 703 from the Web server (which is assumed as the Web server 102 in this case) specified by the URL. Furthermore, the CPU 211 analyzes the obtained contents. More specifically, the CPU 211 communicates with the Web server 102 according to the HTTP protocol, and uses the GET method to obtain the contents (an HTML file corresponding to the screen data) indicated by the URL. Then, the CPU 211 analyzes the description of the obtained HTML file.

After that, based on a result of analyzing the HTML file obtained in step S604, the CPU 211 determines in step S605 whether the Web application designated based on designation of the URL has the menu function. That is, the CPU 211 determines whether it is possible to display an operation screen based on the obtained HTML file as the menu screen on the operation unit 219.

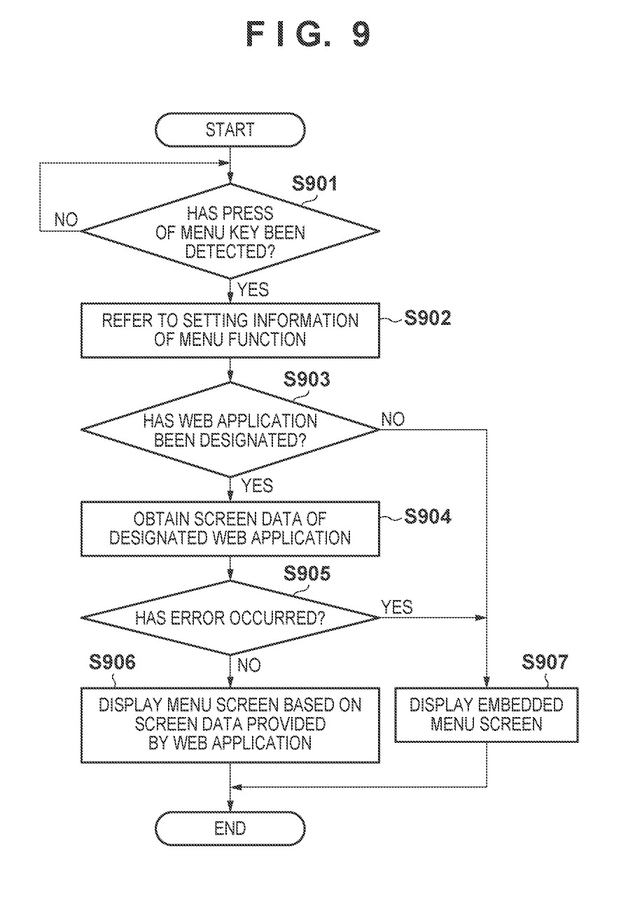

FIG. 8 shows an example (an HTML file 800) of the HTML file obtained from the Web server in step S604. A header 810 contained in the HTML file 800 indicates that the Web application which has generated the HTML file has the menu function (that is, the Web application has provided the screen data of the menu screen). If the Web application of the Web server has the menu function, it generates and transmits an HTML file with the header 810; otherwise, it generates and transmits an HTML file without the header 810.

In step S605, the CPU 211 executes the determination processing in step S605 according to whether the HTML file obtained in step S604 contains the header 810 as information indicating that the HTML file contains the screen data of the menu screen. If the CPU 211 determines that the designated Web application has no menu function, it advances the process to step S606.

In step S606, the CPU 211 restricts setting of the Web application designated in step S601 as an application for providing the menu function. That is, the CPU 211 restricts the use of the screen data of the designated Web application as the screen data of the menu screen. At this time, the CPU 211 displays, on the operation unit 219, a screen (not shown) for notifying the user that it is impossible to set the designated Web application as an application for providing the menu screen because the Web application has no menu function. Then, the CPU 211 returns the process to step S602. With this operation, the CPU 211 accepts designation using another new URL for a Web application (the screen data thereof) in step S602, and re-executes the above processing.

On the other hand, if the CPU 211 determines in step S605 that the designated Web application has the menu function, it advances the process to step S607. In step S607, the CPU 211 confirms, as setting information to be held by the menu screen setting unit 534, the contents which have been set through the screen 700 in step S601, and closes the “menu function setting screen” (the screen 700) being displayed on the operation unit 219. In step S607, setting information indicating the embedded menu screen or the menu screen by the Web application to be used is confirmed as setting information to be held by the menu screen setting unit 534. If it has been set to use the menu screen by the Web application, further information about the URL for specifying the Web application is confirmed as setting information to be held by the menu screen setting unit 534. Note that the setting information is stored in the RAM 213 or HDD 214 as information to be held by the menu screen setting unit 534.

<Processing of Displaying Menu Screen in MFP 101>

Display processing for displaying the menu screen on the operation unit 219 when the menu key 307 arranged on the operation unit 219 is pressed will be described next. FIG. 9 is a flowchart illustrating a processing procedure of displaying the menu screen which is executed when the menu key 307 is pressed in the MFP 101 according to the embodiment. Each operation shown in the flowchart of FIG. 9 is implemented on the MFP 101 when the CPU 211 of the MFP 101 executes a control program (each software modules shown in FIG. 5). More specifically, each operation of FIG. 9 is implemented by a function of the menu screen display unit 535.

Based on information output from the operation unit 219 via the operation unit I/F 215, the CPU 211 determines in step S901 whether press of the menu key 307 has been detected. As long as the CPU 211 determines that press of the menu key 307 has not been detected, it repeats the determination processing in step S901. On the other hand, if the CPU 211 determines in step S901 that press of the menu key 307 has been detected, it advances the process to step S902. In step S902, the CPU 211 refers to the setting information which has been confirmed in step S607 and is held in the RAM 213 by the menu screen setting unit 534, and advances the process to step S903.

Based on the setting information referred to in step S902, the CPU 211 determines in step S903 whether it has been set to use a Web application (that is, it has been set to use screen data provided by a Web application for displaying the menu screen). If the CPU 211 determines that it has not been set to use a Web application (that is, it has been set to use the embedded menu screen), it advances the process to step S907. On the other hand, if the CPU 211 determines that it has been set to use a Web application, it advances the process to step S904.

In step S904, the CPU 211 obtains, from the Web server (which is assumed as the Web server 102 in this case) specified by the URL designated in the setting information referred to in step S902, the contents of the Web application specified by the URL. Furthermore, in step S905, the CPU 211 determines whether the contents have been successfully obtained from the Web server 102. If the CPU 211 determines that the contents have not been successfully obtained due to a communication error or the like, it advances the process to step S907. On the other hand, if the CPU 211 determines that the contents have been successfully obtained from the Web server 102, it advances the process to step S906.

In step S906, the CPU 211 causes the Web browser 540 to analyze the obtained contents (HTML data). Based on the description of the analyzed HTML data, the CPU 211 further obtains an image file, a script file, and the like from the Web server 102, as needed. After that, the CPU 211 causes the Web browser 540 to display, on the operation unit 219, the menu screen according to the description of the obtained HTML data.

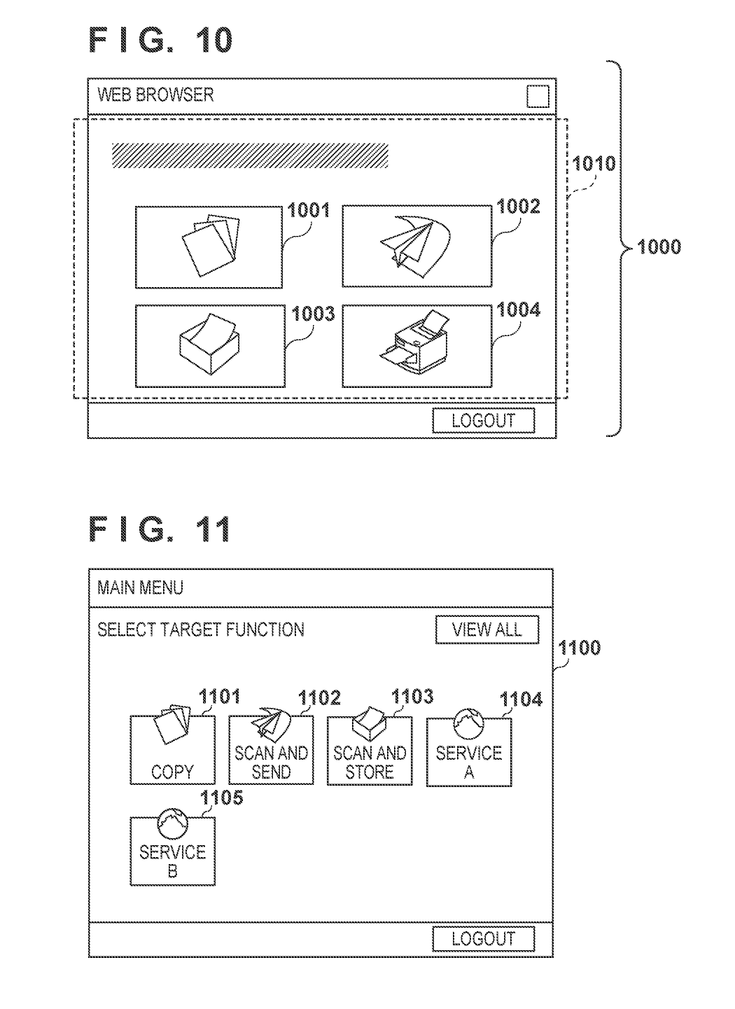

FIG. 10 shows an example (a screen 1000) of the menu screen displayed on the operation unit 219 in step S906. The screen 1000 is displayed on the operation unit 219 by the Web browser 540 according to the description of the HTML data obtained in step S904. An area 1010 indicates the display area of the operation unit 219 (LCD unit 301). As shown in FIG. 10, the screen 1000 includes, within the area 1010, function selection buttons 1001 to 1004 for selecting a function to be executed. When the user selects one of the function selection buttons 1001 to 1004 through the touch panel sheet 302, the operation unit 219 transmits input information indicating the operation to the CPU 211. The CPU 211 causes the Web browser 540 to transmit the input information to the Web application 510.

The Web application 510 issues an application switching request to the application switching service unit 553 included in the service provider 550 of the MFP 101. In this case, the Web application 510 issues, to the application switching service unit 553, a switching request to switch an application to be used to that corresponding to the input information received from the Web browser 540. Upon receiving the switching request from the Web application 510 via the LAN 110, the application switching service unit 553 requests the application switching management unit 532 to switch the application according to the received switching request. In response to the request, the application switching management unit 532 executes application switching processing. In this way, the Web application 510 provides the menu function for the MFP 101.

If the process advances from step S903 or S905 to step S907, the CPU 211 causes the embedded menu function unit 536 to display, on the operation unit 219, the embedded menu screen which has been embedded in the MFP 101 in advance. FIG. 11 shows an example (a screen 1100) of the embedded menu screen displayed on the operation unit 219 in step S907. Each of function selection buttons 1101 to 1105 included in the screen 1100 is used to select a corresponding function (application) to be used. When the user presses one of the function selection buttons 1101 to 1105 through the touch panel sheet 302, the operation unit 219 notifies the CPU 211 of input information indicating the operation. The CPU 211 causes the application switching management unit 532 to switch the running application from the application for displaying the menu screen to an application corresponding to the input information. With this operation, the function (application) selected through the screen 1100 is executed on the MFP 101.

As described above, the CPU 211 uses a function of the embedded menu function unit 536 or Web browser 540 to display, as the menu screen on the operation unit 219, an operation screen based on the screen data which has been embedded in the MFP 101 in advance, or the operation screen provided by the designated Web application 510 instead of the embedded operation screen. Note that the CPU 211 displays, as the menu screen, only an operation screen provided by the Web application 510 which has been designated in step S601 and has been determined to provide the menu screen.

Although the menu key 307 has been described by assuming that it is implemented as a hard key arranged on the operation unit 219, it may be implemented as a soft key displayed on the operation unit 219 (LCD unit 301). Furthermore, the menu screen has been described by assuming that it is displayed on the operation unit 219 when the menu key 307 is pressed. The menu screen, however, may be displayed when, for example, the MFP 101 starts from a power-off state or it is detected that the user has not operated the operation unit 219 for a given period of time.

As described above, in this embodiment, the MFP uses, as the screen data of the menu screen, the screen data which has been embedded in the MFP in advance or the screen data of an external Web server which provides the screen data of an operation screen. More specifically, the MFP accepts designation of, as the screen data of the menu screen, the screen data which has been embedded in the MFP in advance or screen data provided by an external Web server. If screen data provided by a Web server is designated, the MFP obtains the screen data from the Web server, and determines whether it is possible to display an operation screen based on the obtained screen data as the menu screen on the operation unit. If the MFP determines that it is impossible to display, as the menu screen, the operation screen based on the screen data provided by the Web server, it restricts the use of the screen data, and accepts designation of new screen data.

As described above, it is possible to prevent the user from erroneously setting a Web application having no menu function as an application for providing the menu screen. This enables the user to be provided with a function of customizing the menu screen in the MFP.

### Second Embodiment

In the first embodiment, to designate a Web application as an application for providing a menu screen in setting a menu function, the user directly inputs setting information (a URL) for specifying the Web application, as shown in FIG. 7. To the contrary, in the second embodiment, it is possible to select a URL for specifying a Web application from URLs which have been registered in an MFP 101 as “favorites” of a Web browser 540. This reduces the user's labor of inputting a URL for specifying a Web application. A description of the same parts as those in the first embodiment will be omitted as much as possible for the sake of simplicity.

In this embodiment, when a Web application 510 of a Web server 102 provides contents, a CPU 211 can register a URL for specifying the Web application as “favorites” according to a user instruction. A favorites management unit 544 holds the registered information in a RAM 213 or HDD 214 as a management table. Upon accepting registration of the URL by the user, the CPU 211 obtains the Web application 510 (contents thereof) specified by the URL from the Web server 102. Similarly to the first embodiment, the CPU 211 determines whether it is possible to display an operation screen based on the obtained contents as a menu screen on an operation unit 219. The CPU 211 includes, in association with the URL, information indicating the determination result in the management table held by the favorites management unit 544.

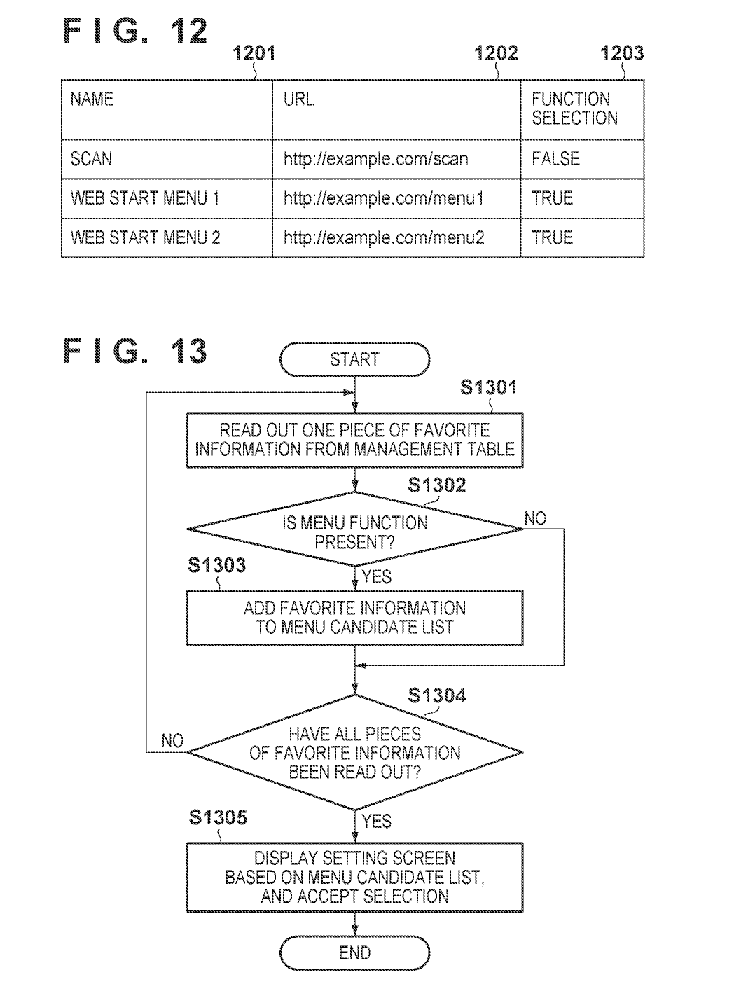

FIG. 12 is a table showing an example of the management table managed by the favorites management unit 544. Each row of FIG. 12 corresponds to one piece of favorite information. A column 1201 indicates the name of favorite information, in which, for example, a header (TITLE information) contained in contents corresponding to a registered URL is registered. A column 1202 indicates a URL registered as a favorite. A column 1203 indicates flag information representing whether a Web application specified by a corresponding URL has a menu function, which corresponds to the above-described information indicating the determination result based on the obtained contents. In FIG. 12, “TRUE” indicates that a corresponding Web application has the menu function, and “FALSE” indicates that a corresponding Web application has no menu function.

<Processing of Setting Menu Function in MFP 101>

FIG. 13 is a flowchart illustrating a processing procedure of setting a menu function used to display, on the operation unit 219, a menu screen for prompting the user to select a function of the MFP 101, which is executed in the MFP 101 according to this embodiment. Similarly to FIG. 6 in the first embodiment, each operation shown in the flowchart of FIG. 13 is implemented on the MFP 101 when the CPU 211 of the MFP 101 executes a control program (each software module shown in FIG. 5). More specifically, each operation of FIG. 13 is implemented by a function of a menu screen setting unit 534. When the user of the MFP 101 performs a specific operation for the operation unit 219 to call a function of the menu screen setting unit 534, the processing of FIG. 13 starts.

In step S1301, the CPU 211 reads out one piece of favorite information from the management table managed by the favorites management unit 544. In step S1302, the CPU 211 determines whether a Web application specified by a URL contained in the readout favorite information has the menu function. In this example, the CPU 211 determines whether flag information in the column 1203 of the management table shown in FIG. 12 is “TRUE”. If the flag information in the column 1203 is “TRUE”, the CPU 211 determines that the corresponding Web application has the menu function, and advances the process to step S1303. On the other hand, if the flag information in the column 1203 is not “TRUE”, the CPU 211 determines that the corresponding Web application has no menu function, and advances the process to step S1304.

In step S1303, the CPU 211 adds the favorite information read out in step S1301 to a menu candidate list held by the menu screen setting unit 534, and advances the process to step S1304. In step S1304, the CPU 211 determines whether all pieces of favorite information included in the management table managed by the favorites management unit 544 have been read out. If the CPU 211 determines that all the pieces of favorite information have not been read out, it returns the process to step S1301 to execute the processing in steps S1301 to S1303 for next favorite information. On the other hand, if the CPU 211 determines that all the pieces of favorite information have been read out, it advances the process to step S1305.

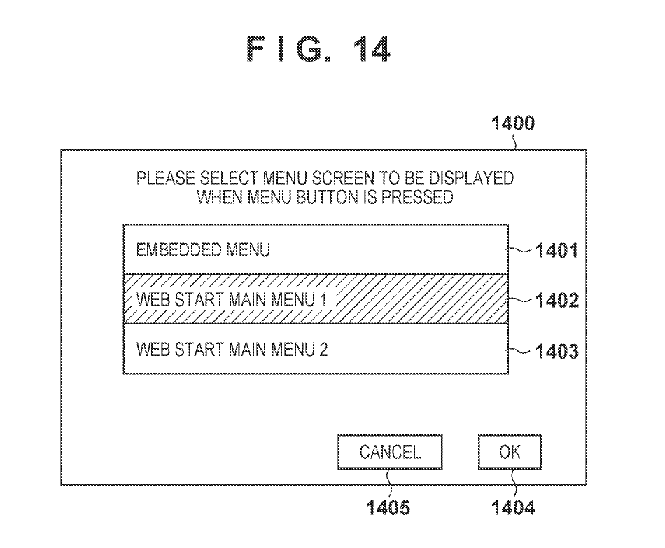

In step S1305, the CPU 211 displays, on the operation unit 219, a menu function setting screen based on the menu candidate list. FIG. 14 shows an example (a screen 1400) of the setting screen displayed on the operation unit 219 in step S1305. As shown in FIG. 14, options 1401 to 1403 are presented in the screen 1400. The option 1401 corresponds to an embedded menu screen, and the option 1402 or 1403 corresponds to favorite information included in the menu candidate list held by the menu screen setting unit 534. As described above, the CPU 211 presents, as options to the user, screen data which has been embedded in the MFP 101 in advance, and screen data which can be specified by the URL registered as favorite information and based on which the menu screen can be displayed on the operation unit 219. When the user selects screen data through the screen 1400, and then presses an OK button 1404, the CPU 211 sets an application to be used as the menu function, that is, selects screen data to be used to display the menu screen.

As described above, in this embodiment, the MFP automatically extracts, as candidates, applications having the menu function among Web applications specified by URLs registered in the MFP as favorite information, and presents them to the user. This enables the user to select an application to be used to display the menu screen from the presented candidates, thereby allowing customization of the menu screen more readily than in the first embodiment. Furthermore, as in the first embodiment, it is possible to prevent the user from erroneously setting a Web application having no menu function as an application for providing the menu screen.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-148622, filed Jul. 4, 2011, which is hereby incorporated by reference herein in its entirety.

What is claimed is:

1. An information processing apparatus which is capable of communicating, via a network, with a server apparatus for providing screen data of an operation screen, comprising:
an acceptance unit configured to accept designation of screen data provided by the server apparatus as screen data of a menu screen for accepting selection of a function of the information processing apparatus to be used;
an obtaining unit configured to obtain the designated screen data from the server apparatus;
a determination unit configured to determine whether it is possible to display, as the menu screen, the operation screen based on the screen data obtained by the obtaining unit on a display unit included in the information processing apparatus; and
a restriction unit configured to restrict, if the determination unit determines that it is impossible to display the operation screen based on the obtained screen data as the menu screen on the display unit, the use of the designated screen data as the screen data of the menu screen.

2. The information processing apparatus according to claim 1, wherein
when the screen data obtained by the obtaining unit contains information indicating that the screen data is the screen data of the menu screen, the determination unit determines that it is possible to display the operation screen based on the screen data as the menu screen on the display unit, and
when the screen data obtained by the obtaining unit does not contain information indicating that the screen data is the screen data of the menu screen, the determination unit determines that it is impossible to display the operation screen based on the screen data as the menu screen on the display unit.

3. The information processing apparatus according to claim 1, wherein
when the restriction unit restricts the use of the designated screen data as the screen data of the menu screen, the acceptance unit accepts designation of new screen data provided by the server apparatus.

4. The information processing apparatus according to claim 1, further comprising
a display control unit configured to display, as the menu screen on the display unit, an operation screen based on screen data which has been embedded in the information processing apparatus in advance, or an operation screen based on screen data of the designated screen data, for which the determination unit has determined that it is possible to display the operation screen based on the obtained screen data as the menu screen on the display unit, instead of the operation screen based on screen data which has been embedded in the information processing apparatus.

5. The information processing apparatus according to claim 4, wherein
when a menu key arranged on an operation unit of the apparatus is operated or the apparatus starts from a power-off state, the display control unit displays the menu screen on the display unit.

6. An information processing apparatus which is capable of communicating, via a network, with a server apparatus for providing screen data of an operation screen, comprising:
an acceptance unit configured to accept registration of specifying information for uniquely specifying screen data of an operation screen provided by the server apparatus;
an obtaining unit configured to obtain the screen data specified by the registered specifying information from the server apparatus;
a determination unit configured to determine whether it is possible to display, as a menu screen for accepting selection of a function of the information processing apparatus to be used, the operation screen based on the screen data obtained by the obtaining unit on a display unit included in the information processing apparatus; and
a selection unit configured to select screen data to be used to display the menu screen from screen data which has been embedded in the information processing apparatus in advance, and screen data which is specified by the registered specifying information and for which the determination unit has determined that it is possible to display the operation screen based on the obtained screen data as the menu screen on the display unit.

7. A control method for an information processing apparatus which is capable of communicating, via a network, with a server apparatus for providing screen data of an operation screen, comprising:
accepting designation of screen data provided by the server apparatus as screen data of a menu screen for accepting selection of a function of the information processing apparatus to be used;
obtaining the designated screen data from the server apparatus;
determining whether it is possible to display, as the menu screen, the operation screen based on the screen data obtained in the obtaining on a display unit included in the information processing apparatus; and
restricting, if it is determined in the determining that it is impossible to display, as the menu screen, the operation screen based on the obtained screen data on the display unit, the use of the designated screen data as the screen data of the menu screen.

8. A control method for an information processing apparatus which is capable of communicating, via a network, with a server apparatus for providing screen data of an operation screen, comprising:
accepting registration of specifying information for uniquely specifying screen data of an operation screen provided by the server apparatus;
obtaining the screen data specified by the registered specifying information from the server apparatus;
determining whether it is possible to display, as a menu screen for accepting selection of a function of the information processing apparatus to be used, the operation screen based on the screen data obtained in the obtaining on a display unit included in the information processing apparatus; and
selecting screen data to be used to display the menu screen from screen data which has been embedded in the information processing apparatus in advance, and screen data which is specified by the registered specifying information and for which it is determined in the determining that it is possible to display the operation screen based on the obtained screen data as the menu screen on the display unit.

9. A computer-readable recording medium recording a computer program for causing a computer to execute steps of the method for controlling the information processing apparatus according to claim 7.

10. A computer-readable recording medium recording a computer program for causing a computer to execute steps of the method for controlling the information processing apparatus according to claim 8.
